(19) United States
(12) Patent Application Publication
(10) Pub. No.: US 2002/0162097 A1
(43) Pub. Date: Oct. 31, 2002

(54) Compiling method, synthesizing system and recording medium

(76) Inventor: Mahmoud Meribout, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/976,286

(22) Filed: Oct. 15, 2001

(30) Foreign Application Priority Data
Oct. 13, 2000 (JP) 2000-313818

(51) Int. Cl. G06F 9/45

(52) U.S. Cl. 717/155; 717/159; 717/143

(57) ABSTRACT

A front-end compiler 103 carries out a syntax analysis of a description file 102 describing a desired electronic circuit model with a predetermined high level description language, to generate a control data flow graph 104 having a predetermined graph structure. A back-end compiler 105 divides the control data flow graph 104 into threads composed of a set of a plurality of connected nodes and achieving a particular function. The back-end compiler 105 optimizes the divided threads to meet with a predetermined area restriction and a predetermined waiting time restriction, to obtain designation information of the number, the function, the placement and routing of logic cells for the desired electronic circuit model. According to a compiling method of the present invention, it is possible to describe the electronic circuit model with a high level description language familiar to a programmer, and also it is possible to carry out a further accurate cost estimation.

### BACKGROUND OF THE INVENTION

The present invention relates to a computer aided design (abbreviated “CAD”), and more specifically to a compiling method and a synthesizing system capable of describing a hardware model in a high level language. The present invention also relates to a recording medium recording a program for realizing the compiling method

Furthermore, the present invention relates to a variety of very large scale integrated circuit (abbreviated “VLSI”) technologies including an application specific integrated circuit (abbreviated “ASIC”), a field programmable gate array (abbreviated “FPGA”) and a dynamic reconfigurable logic (abbreviated “DRL”).

A system for synthesizing hardware with a circuit description by a high level language, is known. This kind of synthesizing system can not only provide the result of a high quality but can also make it possible for a user to describe with the high level language in a designing, so that the user can become free from a structural complexity. A compiler used in this synthesizing system has an advantage capable of realizing hardware having a high throughput by executing a known scheduling and allocation while effectively utilizing various resources.

In a design of the very large scale integrated circuit, there is utilized a set of gates carrying out a binary function such as AND, OR, NOT, FLIPFLOP, etc. and having a specification as to how various gates are interconnected. A layout tool is used for converting an obtained design into a form which is proper for an actual fabrication using a suitable technology. In this design, a conventional method known as a “schematic capture” is used. According to this design method, the user picks up logic gates or gate sets from a library by use of a graphical software tool, and lays the picked-up logic gates or gate sets, and depicts interconnections by using a mouse of a computer machine so as to interconnect the picked-up logic gates or gate sets. Thereafter, for example, the gates are selectively removed and simplified to optimize the obtained circuit without changing the function of the whole circuit. The circuit thus optimized can be presented for a layout and an actual fabrication.

In the above mentioned design method, however, the designer has to consider the logic and the timing for all or most of the gates or the gate sets. Therefore, it is difficult to use this method for a large scale design, and even if it is used, an error is apt to occur.

There is another design technology in which a designer describes an LSI circuit with a hardware description language (abbreviated “HDL”). The description using this HDL is suitable to a gate in a final design, and an input source code is relatively short even if the final design is logically complicated. Accordingly, a logic complexity in design is decreased to the designer. This HDL can be exemplified by the HDL disclosed by IEEE Standard VHDL language Reference Manual, IEEE Std. 1076-1993 IEEE, New York, 1993 and “Verilog” disclosed by D. E. Thomas and P. R. Moorby, “Verilog Hardware Description Language”, Kluwer Academic 1995. The design can be converted into a circuit by using this language together with a suitable synthesizing tool as disclosed by S. Carlson, “Introduction to HDL-based Design Using VHDL”, Synops Inc., CA, 1991 (called “Document 1” hereinafter).

In the case of designing a new VLSI by use of the synthesizing technology using the above mentioned HDL, it is necessary to consider the following problems:

A first problem is that a simulation time is long. In order to overcome this problem, for a circuit reserved in a disk or a random access memory (RAM), it makes it possible for a software engineer to grasp the circuit with a high level programming language which can be used in a system known as a C. A. workstation provided with a standard compiler which compiles and executes a test using an input set, known as a vector. Then, at a next step, the C programming language is converted into more suitable language so that a hardware engineer can carries out a hardware synthesis such as “VHDL Register Tranfer Level (RTL)” disclosed in the above referred Document 1, and simulation. In this case, however, since there is no direct correlation between the C version and the HDL version, an error may often occur in the HDL description, and therefore, a test at this stage becomes important.

A second problem is that there is not a high level optimizing technology supplied by a typical compiler such as a loop unwinding or a constant propagation/variable propagation. This problem is further aggravated with increase of the Verilog codes, attributable to the number of transistors provided in a single integrated circuit and the arrival of an on-chip technology. This compels the user to expend a long time for a manual optimization.

From the above mentioned problems, it is demanded to elevate the level of the abstract conception. As a technology for fulfilling this demand, there is a high level synthesis (HLS). A known HLS tool includes a Handel compiler and a Handel-C compiler, as disclosed in I. Page and W. Luck, “Compiling Occam into FPGAs”, pp271-283, Abingdon EE and CS books, 1991. The Handel compiler receives source codes written in language known “Occam”, as disclosed in Inmos, “The Occam 2 Programming Manual”, Prentice-Hall International, 1988. The Occam is a language similar to the C language, but has an extra structure expressing a parallel processing and a synchronous point-to-point communication through a designated channel. The Handel-C compiler is almost the same as the Handel compiler, but is somewhat different from the Handel compiler in source language. Therefore, it is amenable to a programmer familiar to the C language. For example, the programmer controls the whole timing of respective structures. Each structure is allocated with an accurate number of cycles (this is called a “Timed Semantics”). Therefore, the programmer must consider all low level parallel processing in the designing, and also must know how the compiler allocates the clock cycles to each structure.

However, since one cycle is required to all the allocations, multiplication of both is required in order for both to occur in a single cycle. This means that two multipliers must be provided, and therefore, an extra area is required. In addition, since the multiplier must be operated in the single cycle, the clock speed becomes slow.

As a compiler for overcoming the above mentioned problem, some compilers having an elevated level of abstraction have been proposed. Most of these tools adopts a continuous method of first executing the HLS, secondly generating a hardware application net list file. In this case, however, the method does not often meet with an area of an available target hardware or a throughput specification of an application. In such a situation, it is not possible to provide an accurate configuration overhead or layout metrics (layout index) at an initial stage of a design flow. In addition, since the decision in the design cannot be canceled from an initial design stage, the processing is iterated until a suitable solution is obtained.

A method for overcoming the above mentioned problem by using the layout metrics has been proposed. For example, M. Vasilco, D. Jibson and S. Holloway, “Towards a Consistent Design Methodology for Run-time Reconfigurable Systems” described in Reconfigurable System IEE Expert Conference opened in Glasgow, Scotland on Mar. 10, 1999, Digest No. 99/061, and P. Lysaght, “Towards an Expert System for a Priori Estimation of Reconfiguration Latency in Dynamically Reconfigurable Logic”, ([3] on pages 183-193). However, in order to accurately estimate the metrics (index) in these methods, a placement and a detailed interconnection of a designed module is required for each design architecture and structure schedule. This is very simple design, but not practical. Because of this reason, most of the tools uses only function unit (FU) models. This makes it further difficult to handle in realizing a further high level of optimization, with the result that the following difficult conditions are required:

(1) In order to optimize a function share of an area/throughput, effective libraries connected to be executed by each FU is required. Incidentally, some portions of applications requires a high speed multiplier, but it is sufficient if the other portions are a low speed multiplier.

(2) It is necessary to seek an effective FU which gives a maximum boundary number of cells in a basic hardware in a target VLSI circuit, which shares a whole code program. This is an optimum number of each kind of FUs used for realizing a high throughput.

(3) Most of CAD tools are required to keep a large hardware for a multiplexor, in view of hardware shared at the FU level. This is important in particular for the DRL/FPGA circuit because the cost of the multiplexor is high.

### BRIEF SUMMARY OF THE INVENTION

Accordingly, it is an object of the present invention to provide a compiling method and a synthesizing system which have overcome the above mentioned various problems, and which can describe an electronic circuit model with a high level description language familiar to a programmer and which can carry out a further accurate cost estimation.

Another object of the present invention is to provide a recording medium storing a program capable of executing such a design.

In order to achieve the above objects of the present invention, a compiling method in accordance with the present invention includes a first step of carrying out a syntax analysis of a description file describing a desired electronic circuit model with a predetermined high level description language, to generate a control data flow graph having a predetermined graph structure, and a second step of dividing the control data flow graph into threads composed of a set of a plurality of connected nodes and achieving a particular function, and optimizing the divided threads to meet with a predetermined area restriction and a predetermined waiting time restriction, to obtain designation information of the number, the function, the placement and routing of logic cells for the desired electronic circuit model.

In the above case, the optimization in the second step can be carried out by estimating a minimum boundary of an area and a waiting time in connection with any of a function unit, a register and a multiplexor.

Alternatively, the optimization in the second step can be carried out by first optimizing the divided threads to meet with the predetermined area restriction, and thereafter optimizing the optimized threads to meet with the predetermined waiting time restriction.

The second step can include a top-down processing step carrying out the optimization in connection with the predetermined area restriction and the predetermined waiting time restriction, in the order from a highest level divided thread, and a down-top processing step of dividing a lower level divided thread optimized in the top-down processing step, into some number of threads, to assemble into a predetermined context or a predetermined circuit.

In the above case, the top-down processing step can include:

a first dividing step for dividing the control data flow graph into threads composed of a set of the plurality of connected nodes and achieving the particular function;

a first scheduling step of allocating a predetermined control step and a thread moving range in that step for a thread obtained in the first dividing step, the first scheduling step also allocating the order of priority for the threads respectively allocated with the control steps, in accordance with a plurality of priority order lists previously set;

a first area restriction determining step for estimating a total area of the threads allocated in the first scheduling step, and of determining whether or not the estimated total area meets with the predetermined area restriction;

when it is determined in the first area restriction determining step that the estimated total area does not meet with the predetermined area restriction, a similarity cost calculating step for calculating a similarity cost in connection with an area for all thread pair combinations of the threads obtained in the first dividing step;

a first allocation step of selecting, from the thread pairs, a thread pair belonging to different control steps and having a further high similarity cost, with reference to the similarity costs obtained in the similarity cost calculating step, the first allocation step further obtaining a new thread by combining the selected thread pair as a new thread to another thread;

a second area restriction determining step for estimating a total area for the new thread pair obtained in the first allocation step, and of determining whether or not the estimated total area meets with the predetermined area restriction;

when it is determined in the second area restriction determining step that the estimated total area does not meet with the predetermined area restriction, an allocation-scheduling step of selecting, from the threads included in the list, a thread pair belonging to the same control step and having a further high similarity cost, in accordance with the plurality of priority order lists, in the order from a low priority list, the allocation-scheduling step obtaining a new thread pair by combining the selected thread pair as a new thread to another thread, and subdividing the control step allocated to the new thread pair, into two control steps having the same content;

when it is determined in the first or second area restriction determining step that the estimated total area meets with the predetermined area restriction, a thread processing step of investigating a trade-off between the area restriction and the waiting time restriction for the new thread pair obtained in the first allocation step or in the allocation-scheduling step, and carrying out the placement and routing of nodes to meet with both the restrictions.

The down-top processing step can include a second scheduling step of selecting and separating, for the threads placed and routed in the thread processing step, a thread pair having a low similarity, from the threads included in the list, in accordance with the plurality of priority order list, in the order from a high priority list, and a second dividing step of assembling the thread pairs separated in the second scheduling step, into a context or a circuit which minimizes a connecting restriction between threads.

A synthesizing system in accordance with the present invention includes a front-end compiler means for carrying out a syntax analysis of a description file describing a desired electronic circuit model with a predetermined high level description language, to generate a control data flow graph having a predetermined graph structure, and a back-end compiler means for dividing the control data flow graph into threads composed of a set of a plurality of connected nodes and achieving a particular function, and optimizing the divided threads to meet with a predetermined area restriction and a predetermined waiting time restriction, to obtain designation information of the number, the function, the placement and routing of logic cells for the desired electronic circuit model.

In the above case, the back-end compiler means can be constructed to carry out optimization by estimating a minimum boundary of an area and a waiting time in connection with any of a function unit, a register and a multiplexor.

The back-end compiler means can include:

a first dividing means for dividing the control data flow graph into threads composed of a set of the plurality of connected nodes and achieving the particular function;

a first scheduling means of allocating a predetermined control step and a thread moving range in that step for a thread obtained in the first dividing means, the first scheduling means also allocating the order of priority for the threads respectively allocated with the control steps, in accordance with a plurality of priority order lists previously set;

a first area restriction determining means for estimating a total area of the threads allocated in the first scheduling means, and for determining whether or not the estimated total area meets with the predetermined area restriction;

when it is determined in the first area restriction determining means that the estimated total area does not meet with the predetermined area restriction, a similarity cost calculating means for calculating a similarity cost in connection with an area for all thread pair combinations of the threads obtained in the first dividing means;

a first allocation means of selecting, from the thread pairs, a thread pair belonging to different control steps and having a further high similarity cost, with reference to the similarity costs obtained in the similarity cost calculating means, the first allocation means further obtaining a new thread by combining the selected thread pair as a new thread to another thread;

a second area restriction determining means for estimating a total area for the new thread pair obtained in the first allocation means, and for determining whether or not the estimated total area meets with the predetermined area restriction;

when it is determined in the second area restriction determining means that the estimated total area does not meet with the predetermined area restriction, an allocation-scheduling means for selecting, from the threads included in the list, a thread pair belonging to the same control step and having a further high similarity cost, in accordance with the plurality of priority order lists, in the order from a low priority list, the allocation-scheduling means obtaining a new thread pair by combining the selected thread pair as a new thread to another thread, and subdividing the control step allocated to the new thread pair, into two control steps having the same content;

when it is determined in the first or second area restriction determining means that the estimated total area meets with the predetermined area restriction, a thread processing means of investigating a trade-off between the area restriction and the waiting time restriction for the new thread pair obtained in the first allocation means or in the allocation-scheduling means, and carrying out the placement and routing of nodes to meet with both the restrictions;

a second scheduling means for selecting and separating, for the threads placed and routed in the thread processing means, a thread pair having a low similarity, from the threads included in the list, in accordance with the plurality of priority order list, in the order from a high priority list; and

a second dividing means for assembling the thread pairs separated in the second scheduling means, into a context or a circuit which minimizes a connecting restriction between threads.

A recording medium in accordance with the present invention records a computer program for causing a computer to execute a processing for carrying out a syntax analysis of a description file describing a desired electronic circuit model with a predetermined high level description language, to generate a control data flow graph having a predetermined graph structure, and another processing for dividing the control data flow graph into threads composed of a set of a plurality of connected nodes and achieving a particular function, and optimizing the divided threads to meet with a predetermined area restriction and a predetermined waiting time restriction, to obtain designation information of the number, the function, the placement and routing of logic cells for the desired electronic circuit model.

As seen from the above, the present invention provides a novel CAD technology for a hardware system. A principal concept of this technology is that a gap between a high level synthesizing tool and a low level synthesizing tool is filled up. Thus, an input language can be that which is at a high level and is familiar to a programmer, and which can support most of important structures having an expression which can be understood in hardware.

In the present invention, first, optimization is carried out with a relatively high level, and a control data flow graph (abbreviated “CDFG” hereinafter). This CDFG is divided into connected clusters having an independent node, called a thread. In this method, the scheduling, the allocation and the division are carried out at a thread level, not at a single operation level. Particularly, when a FU delay is shorter than a user's clock cycle, this can give a high throughput to a system, and also can reduce the complexity of HLS. In addition, for each of the threads mentioned above, at a first stage in the compiler, a minimum boundary of an area and a waiting time are simultaneously carried out for a function unit, a register and a multiplexor. Furthermore, at a final stage of the compiler, the cost for the placement and routing is considered to obtain a more accurate cost estimation.

Moreover, according to the present invention, in order to realize a high performance-area tradeoff, a library connecting is effectively carried out.

Further, in the present invention, when the depth of at least one branch exceeds a predetermined threshold value, the thread is formed of connecting nodes, and is defined as a block which is found out between two continuous memory accesses or I/O accesses sharing an I/O port, or as an express machine introduced by a user, or as a fork-joint node of a control graph. With this arrangement, since a high level synthesis can be applied to a group of threads, not to a simple node, it is possible to shorten the compiler execution time. Furthermore, such independent threads can be efficiently utilized in connecting the libraries and in the placement and routing.

In addition, in the present invention, not only the tradeoff between the area and the waiting time is considered for each thread, but also the cost of the connecting and the closeness of the library are added. In order to minimize the interconnection length, the distance of the closeness is investigated in the threading. This is particularly effective in a sub-micro technology, since an interconnection delay is more significant than a hardware delay.

In the front-end compiler in the present invention, it is possible to consider the delay in the hardware cell, the register and multiplexor, in calculation of the wait time. The accuracy of the delay restriction can be elevated by considering a critical path at a final stage of a design flow tool.

As a cost used in the designing, a concurrency condition, a similarity condition, a connectivity condition and a branch condition can be used. IN the present invention, these costs are repeatedly used to increase the efficiency of the processing. Here, the similarity is to smoothly give an influence on the throughput of the system in accordance with a concurrency cost and a pipeline cost in the allocation. Thereafter, in order to minimize the interconnection between chips, or in order to reduce the number of registers in the case of DRL, the connectivity metrics is used.

In the present invention, when the control steps are allocated to the respective threads, the threads are located in accordance with the priority order list. The thread moving range, the thread lifetime, the branch condition, the parallel thread and the pipelined threads are considered as condition in carrying out optimization.

When it is decided that the number of hardware is not sufficient, the similarity cost is calculated. A corresponding data structure can be constituted in the form of a matrix. When the thread shares two or more function units, it is possible to minimize the number of multiplexors with the allocation, with the result that the thread waiting time can be shortened.

In the allocation, it is possible to use the multiplexor or various contexts. In addition, the allocation is carried out for only the threads which do not belong to the same segment step.

The allocation-scheduling is used for gradually increasing the throughput of the designed system. In this allocation-scheduling, the thread belonging to a lowest priority list and having a highest similarity metrics, is executed. Thereafter, the corresponding control step is divided into two control steps. Further, the area is estimated, and the processing is iterated until all elements included in the list are processed. After this allocation-scheduling, the threading is carried out. A hardware pipeline is generated for the thread which further reduces the area, belongs to a loop and does not meet with the waiting time restriction. This includes two steps includes a thread adjustment and a thread optimization. In the thread adjustment, it is possible to use a hardware cell model, a multiplexor model and a register model for area/delay evaluation. Thus, the waiting time restriction for all the threads can be ensured.

For a timing analysis, it is possible to use an Elmore delay model in order to accurately evaluate the waiting time of each thread. For the thread which does not meet with the waiting time, the thread is divided by inserting an obtained number of registers between nodes. At this stage, when the waiting time restriction is satisfied, the library connecting is carried out in order to further reduce the area. In this library connecting, it is possible to use different versions of the same kind of function units. Since this does not become a clear task for another high level synthesizing system, in this case it is an ordinary practice to use the same kind of function units.

### BRIEF DESCRIPTION OF THE DRAWINGS

FIG. 1 is a flow chart for illustrating one example of a high level design flow which is one embodiment of the compiling method in accordance with the present invention;

FIGS. 2a and 2b illustrate examples of a high level input description file;

FIG. 3 is block diagrams for illustrating an example of LSI circuits used in the design flow shown in FIG. 1;

FIG. 4 is a block diagram illustrating one structural example of a general purpose computer system to which the high level design flow shown in FIG. 1 is applied;

FIG. 5 is a flow chart illustrating a processing flow in the back-end compiler shown in FIG. 1;

FIG. 6 illustrates one structural example of a target hardware which constitutes a memory capable of receiving and outputting an image and audio data and a description example of a plurality of applications therefor;

FIG. 7 illustrates the result of memory distribution crossing over tiles when the target hardware and the applications shown in FIG. 6 is applied to the processing shown in FIG. 5;

FIG. 8 illustrates the result of a thread extraction for the example shown in FIG. 6;

FIG. 9 illustrates the result of a similarity cost measurement for the example shown in FIG. 6;

FIG. 10 illustrates the result of a first scheduling for the example shown in FIG. 6;

FIGS. 11a and 11b diagrammatically illustrate an allocation manner of a function unit sharing in the case of DRL;

FIGS. 12a, 12b and 12c stepwise illustrate the result of an allocation-scheduling for the example shown in FIG. 6;

FIG. 13a diagrammatically illustrates a moving range restriction;

FIG. 13b diagrammatically illustrates a thread sharing restriction;

FIG. 13c diagrammatically illustrates a pipeline restriction;

FIG. 14 is a flow chart for illustrating one example of a thread adjusting procedure;

FIG. 15 is a flow chart for illustrating one example of a thread optimizing procedure;

FIG. 16 illustrates one example of a label allocation and a critical path, which is the result of a node clustering of the threads shown in FIGS. 12a, 12b and 12c;

FIG. 17 illustrates one example of a closeness matrix calculation, which is the result of a node clustering of the threads shown in FIGS. 12a, 12b and 12c;

FIG. 18 illustrates one example of a cluster tree, which is the result of a node clustering of the threads shown in FIGS. 12a, 12b and 12c; and

FIG. 19 illustrates one example of a combination of a register re-timing, which is the result of a node clustering of the threads shown in FIGS. 12a, 12b and 12c;

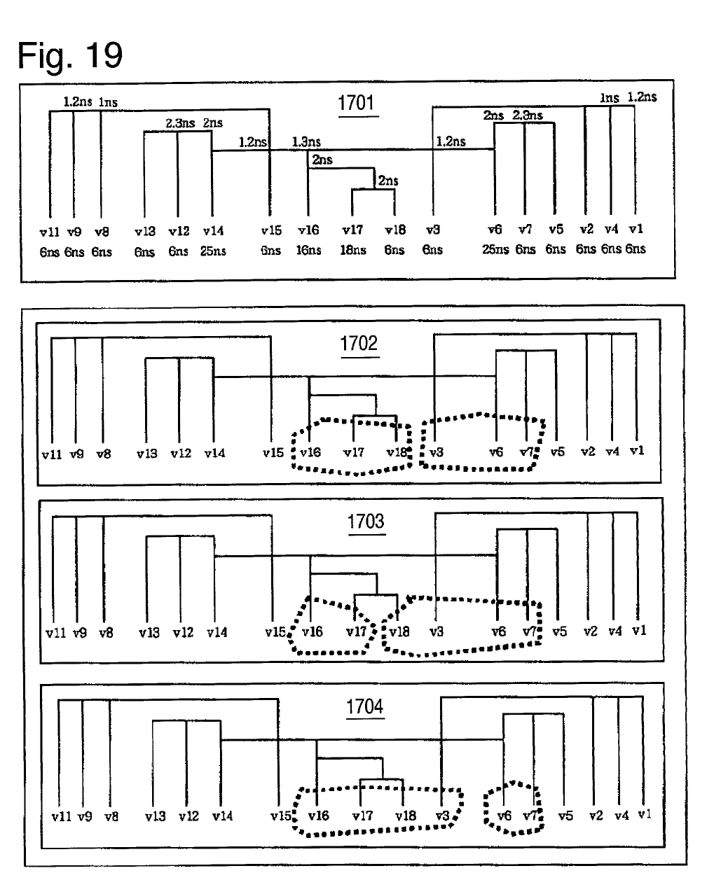

### DETAILED DESCRIPTION OF THE INVENTION

Now, embodiments of the present invention will be described with reference to the drawings.

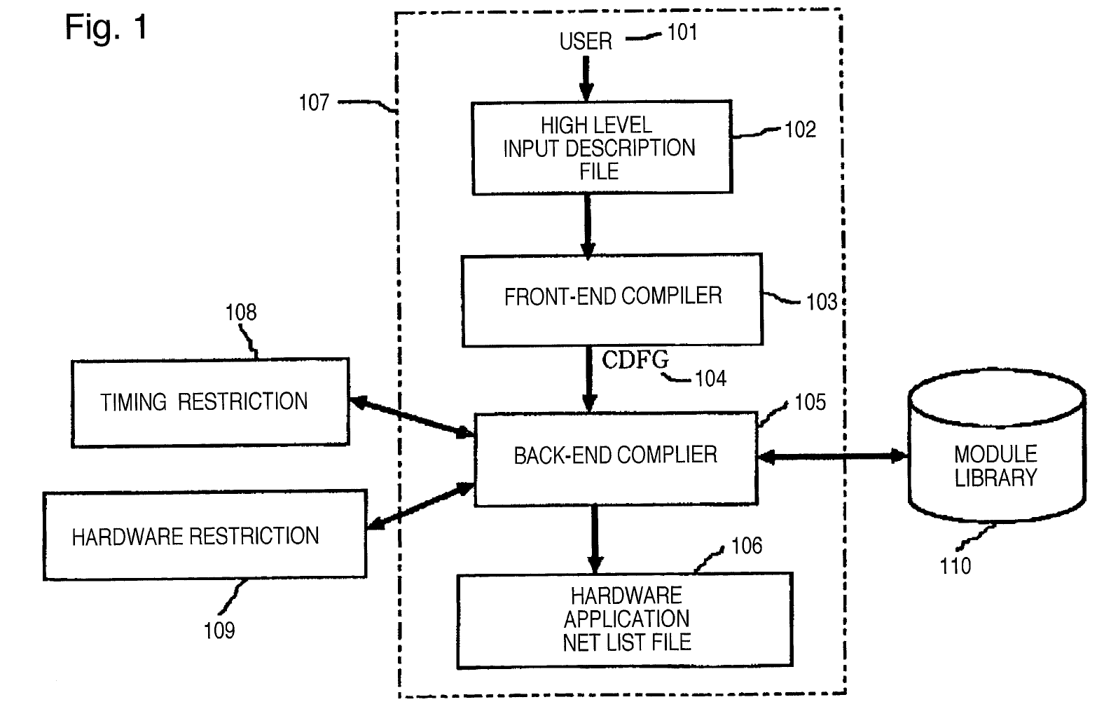

FIG. 1 illustrates one example of a high level design flow to which the compiling method in accordance with the present invention is applied. This high level design flow is a processing carried out in a system for designing a circuit by use of a computer (CAD). A portion surrounded by a dotted line is a processing executed in a logic synthesizing system 107. This processing executed in the logic synthesizing system 107 can be applied to generation of a circuit such as ASIC and FPGA or a logic circuit such as DRL.

First, a user 101 inputs a high level input description file 102, and carried out an interactive processing (a data processing for solving a problem while a human being gives an instruction through a terminal to a computer). The high level input description file 102 is in a text format which can be described by using an existing high level language such Java, C-language or C++ language. The high level input description file 102 can support some number of hardware extensions which are not included in such a language.

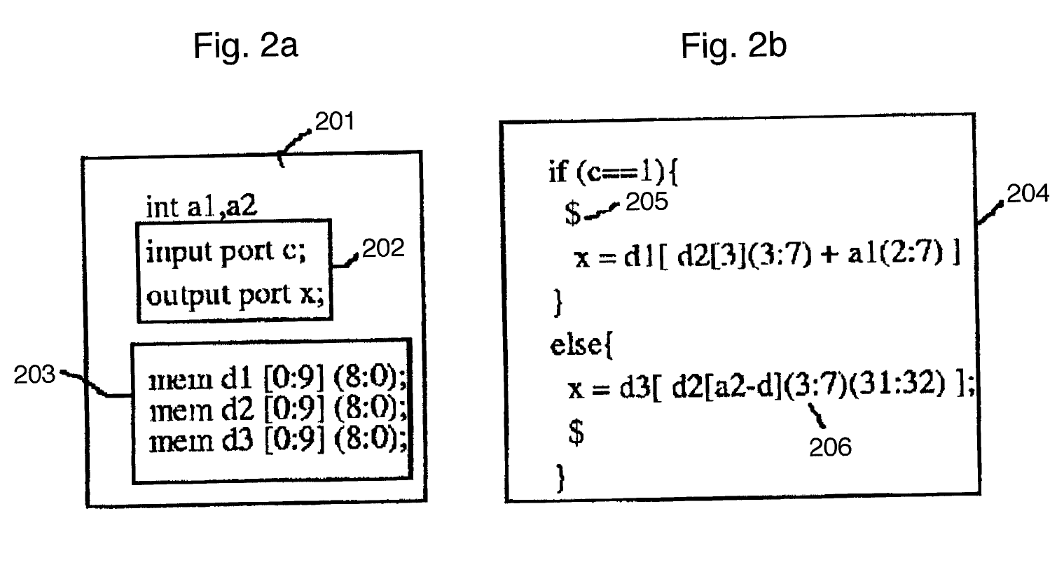

FIGS. 2a and 2b illustrates examples of such hardware extensions. The hardware extensions 201 and 204 shown in FIGS. 2a and 2b, are a description for supporting the hardware extension, described the above mentioned high level input description file 102. Here, respective hardware extension examples of an I/O port specification 202, a memory specification 203, an express status machine insertion 205, and a bit level handling 206 are shown. In the I/O port specification 202, variables “c” and “x” are allocated to an input port and an output port, respectively. In this case, it is possible to support allocation of the pin number. In the memory specification 203, variables “d1” and “d2” are allocated to a two-dimensional memory having a data width of 9 bits. In the express status machine insertion 205, when a conditional variable “c” is equal to “1” (one), one idling cycle is added before the variable “x” is determined, but if “c” is not equal to “1”, one idling cycle is added after the variable “x” is determined. In this extension, the language such as Java, characterized by a mutual task synchronizing mechanism, is not required. In the bit level handling 206, it is possible to designate the bit level.

A front-end compiler 103 can process almost language syntax including an expression having a function with a parameter and a function calling. Accordingly, the processing in this front-end compiler 103 makes easier a working of a software developer familiar to such languages, and does not require a sufficient knowledge of hardware to the software developer. In addition, the front-end compiler 103 carries out a syntax analysis for the input description file 102, and outputs a control data flow graph (CDFG) 104 which is an intermediate format of the syntax analysis.

A back-end compiler 105 carries out a processing (which will be described in detail hereinafter) including an optimization for the data structure syntax-analyzed by the front-end compiler 103, and generates a hardware application net list file 106. This back-end compiler 105 serves as a manager connected to a server through an interface and including a module library 110. The hardware application net list file 106 includes the designation information of the number, function, placement and routing of cells being used. In the case of a multi-context DRL and a multi-chip hardware, the file 106 includes information of the contexts or the chips allocated. The module library 110 supplies a set of function units (FU) having various kinds of parameters possible to set and having a corresponding area and a corresponding delay.

In the optimization of the back-end compiler 105, a hardware restriction (area restriction) 109 and a time restriction (waiting time restriction) 108 are considered. For example, in the designing flow shown in FIG. 1, if the total generated hardware amount (for example, the number of cells, processing devices and transistors) is not greater than an available hardware amount, the hardware restriction 109 is ascertained, and if the number of generated cycles is not greater than a requested number, the time restriction 108 is ascertained.

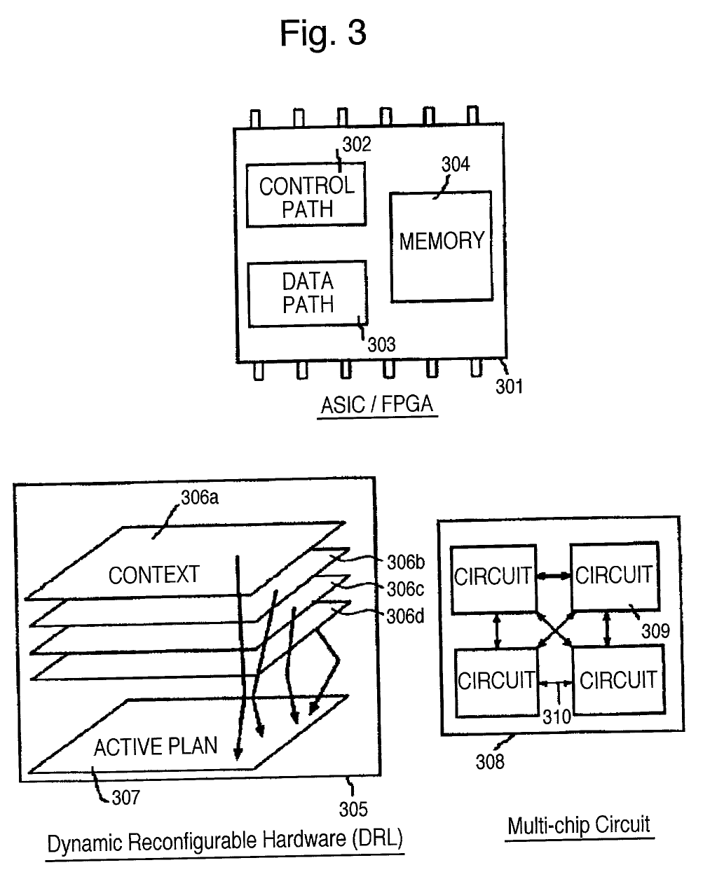

FIG. 3 illustrates various kinds of LSI circuits to which the design flow shown in FIG. 1 can be applied.

FIG. 3(a) is a diagram illustrating the structure of an ASIC or FPGA device. The ASIC or FPGA device shown in FIG. 3(a) includes a control path 302, a data path 303 and an arbitrary embedded memory 304.

FIG. 3(b) is a diagram illustrating the structure of DRL. The DRL shown in FIG. 3(b) includes a plurality of contexts 306a to 003d having a standard construction, and an active plan 307. In this structure, one context is activated at one time.

FIG. 3(c) is a diagram illustrating the structure of a multi-chip circuit. The multi-chip circuit shown in FIG. 3(c) includes a plurality of circuits 309 mutually connected through an interconnection network 310.

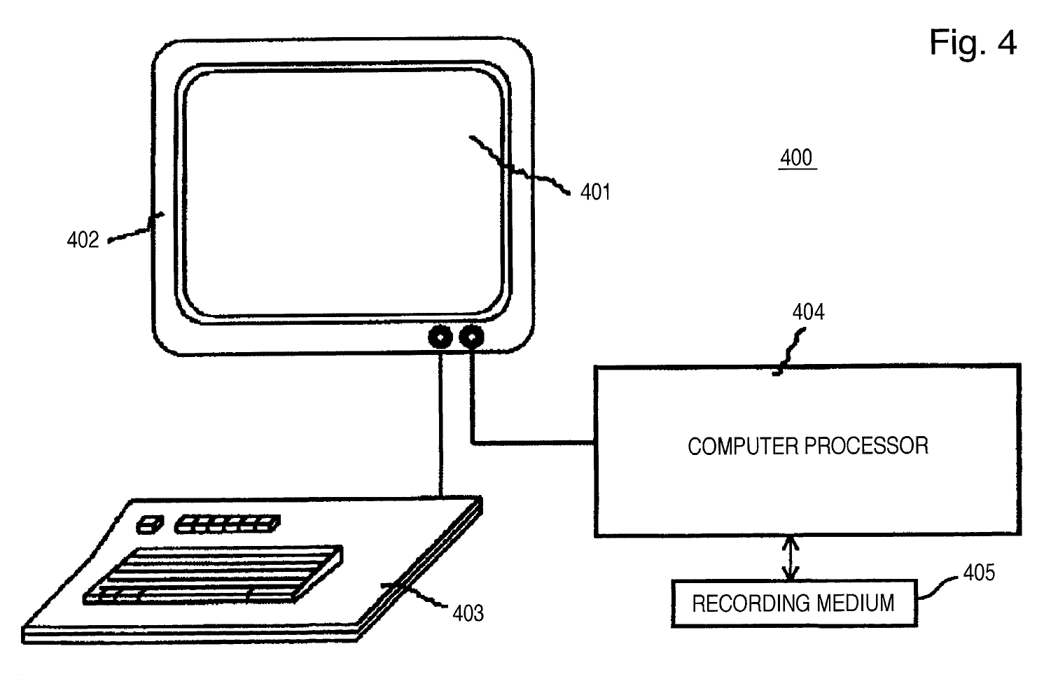

This embodiment of the high level design flow as mentioned above can be realized by using a general purpose computer system as shown in for example FIG. 4. The general purpose computer system shown in FIG. 4 includes a graph display monitor 401 having a graph displaying screen 401 for displaying a graphic information and a text information, a keyboard 403 for inputting the text information, a computer processor 404 and a recording medium 405 recording a compile program. The computer processor 404 is connected to the keyboard 403 and the display monitor 401. In this embodiment, a program code for realizing the above mentioned high level design flow is supplied from the recording medium 405 to the computer processor 404, so that various compile processings explained hereinafter are executed. As the computer processor 404, it is possible to use a well-known various types computers including a main frame computer, a mini computer or a personal computer. The recording medium 405 may be a magnetic disk, a semiconductor memory or another recording medium.

Now, the processing in the back-end compiler 105 will be described in detail.

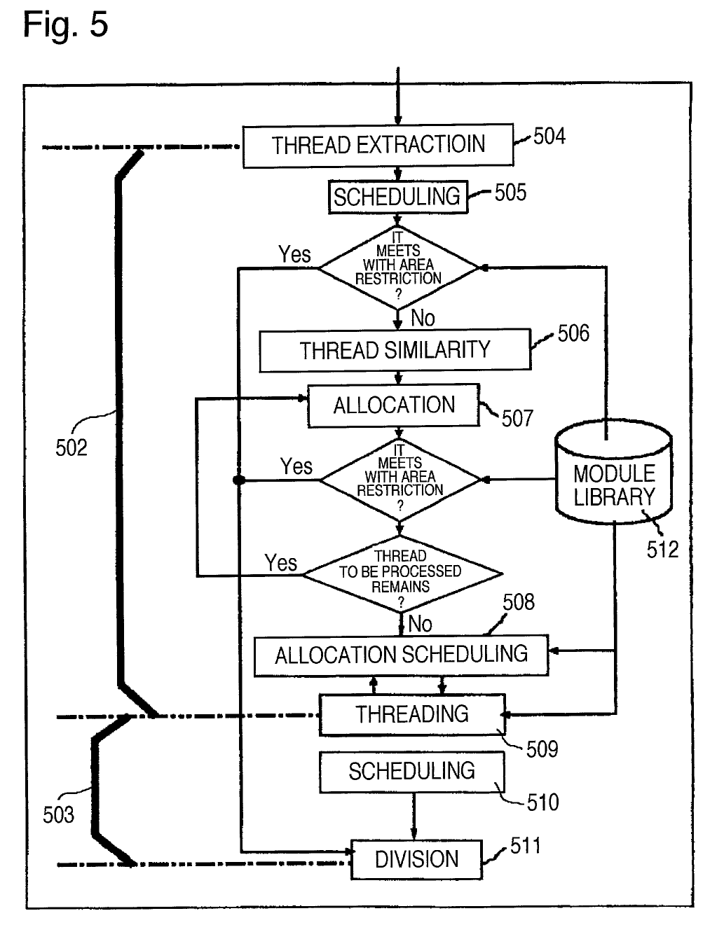

FIG. 5 is a flow chart illustrating the flow of the processing in the processing in the back-end compiler 105. The processing in the back-end compiler 105 can be divided into two phases, namely, a top-down phase 502 and a down-top phase 503.

In the top-down phase 502, first, in order to sort connecting nodes featured with some number of properties into independent threads, a thread extraction 504 (which is a first division) is carried out. Here, the connecting node is a node connected to a branch in the graph, and the thread is an independent cluster of those connecting nodes (a combination of modules for achieving a particular function, composed of a set of a plurality of connected nodes). If the thread is extracted, a scheduling 505, a thread similarity 506, an allocation 507 and an allocation-scheduling 508 are carried out step by step for the extracted thread. Thus, optimization is executed. The processing carried out in each step will be explained in detail in connection with an embodiment explained hereinafter.

After the optimization is executed, each of the threads thus obtained is processed by independently recalling a threading 509 which is a low level synthesizing module, from a module library 512. In this threading 509, the timing restriction 108 shown in FIG. 108 is ascertained. The purpose of this processing is to guarantee that each waiting time restriction is satisfied for each thread. This task is accurate, since an index of the area/cost at a layout level is used.

On the other hand, in the down-top phase 503, for each thread subjected to the treading, a processing for further increasing the throughput of the system is carried out. Namely, in this down-top phase 503, some number of threads combined in the second scheduling 508 of the above mentioned top-down phase 502 are separated in a third scheduling 510, and finally, in a second division 511, the separated threads are assembled into various contexts for DRL or various circuits for the multi-chip hardware.

Embodiments

Now, the processing of the above mentioned back-end compiler will be described in detail. Here, to make it easier to understand the operation, an actual method in consideration of the multi-thread application will be described.

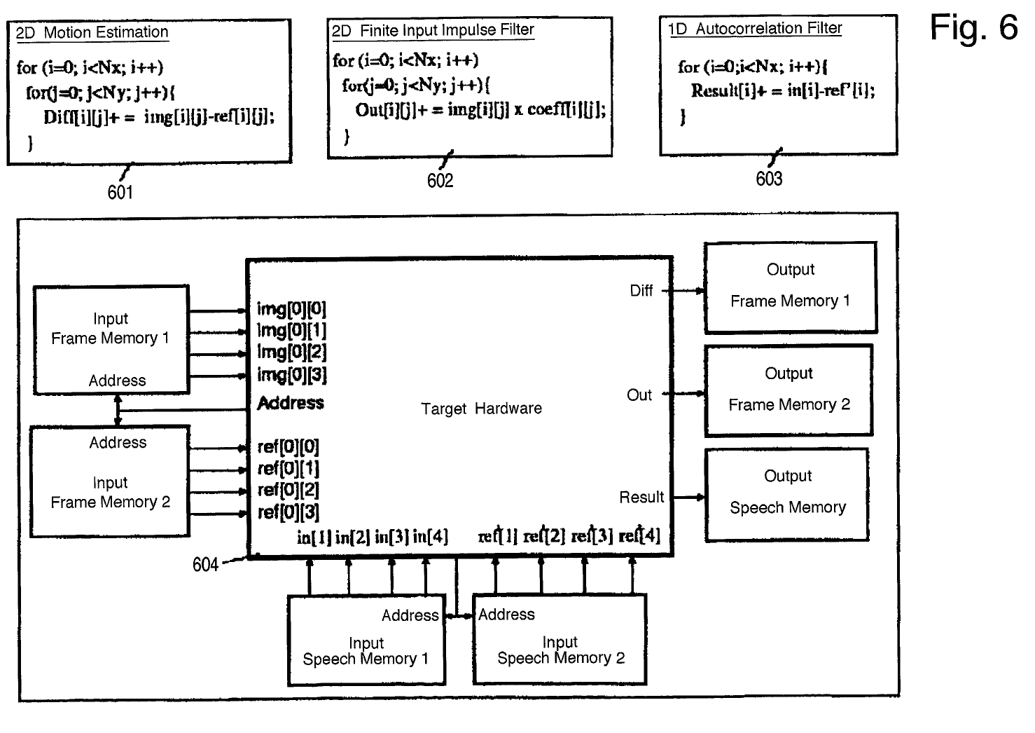

FIG. 6 illustrates one structural example of a target hardware which constitutes a memory capable of receiving and outputting an image and audio data and a description example of a plurality of applications therefor. The example shown in FIG. 6 is an example considering a combination of an image processing application and an audio processing application. A motion estimation 601 which is a first application, and a 2-D finite impulse (FIR) filter 602, which is a second application, can be executed simultaneously. An autocorrelation filter 603, which a third application, applies an autocorrelation to the audio signal. It is on the premise that all input data has a width of 8 bits. The purpose of the processing in the back-end compiler is to achieve a throughput as high as possible, with a minimum amount of hardware. In this example, the target hardware 604 includes 12 input ports and three output ports, and four items of input data can be processed simultaneously for each application.

In the following, each processing will be described in detail on the case that the back-end compiler processing shown in FIG. 5 is applied to the structure shown in FIG. 6.

{First division}

In the thread extraction 504 which is the first division, a thread which is a group of connecting nodes, is extracted from CDFG. This thread is defined as a block composed of a group of connecting nodes. When the depth of at least one branch exceeds a predetermined threshold value, the thread is extracted on the basis of two continuous memory accesses or I/O accesses sharing the same I/O port, an express condition machine introduced by a user, an express thread process, and a branched connecting node of a control graph. The thread extracted in this processing is preferred to meet with the following condition on the basis of the size (the number of connecting nodes).

(a) In order to reduce the complexity in time of a low level portion of the hardware synthesis (technical mapping, and the placement and routing), the thread is made sufficiently small. The reason for this is that the I/O access frequently occurs in a program, in particular, in a multi-media application.

(b) In order to reduce the complexity in time of a high level portion of HLS by carrying out the optimization of the thread rather than a single processing, the thread is made sufficiently large. This elevates an advantage for FPGA rather than a processor/DSP, by simultaneously carrying out a series of plural processings. The reason for this is that it includes, in addition to the series of plural processings, some number of I/O ports for the ASIC, FPGA and DRL, to cause the same thread to include the simultaneously occurring I/O accesses. Furthermore, since a sufficient number of registers are provided by the target VLSI circuit, intermediate variables are preserved in internal registers rather than in an external memory. In addition, the design tool of this embodiment mentioned above is effective in reducing the lifetime of those intermediate variables.

In the case of a loop including a memory access, in order to determine whether or not a memory parallel exists in a iterated operation, data and a loop extension dependency must be given. The purpose of this processing is to “hing on” the determination of a static access in order to investigate the memory parallel. This is carried out by distributing the data which is frequently accessed together, over memories, namely, “tiles”. In this case, when the array is uniformly distributed in an interleaving order of a low order level (which corresponds to the order of each module in an interleaving which give addresses over modules in the case that a main memory is divided into a plurality of modules which can be simultaneously accessed). Namely, continuous elements in the data structure are interleaved over continuous tiles by a round robin method. This layout is desirable since a spatial closed-array access is temporarily closed. Then, the loop is iterated in order to enable a parallel access by converting the codes.

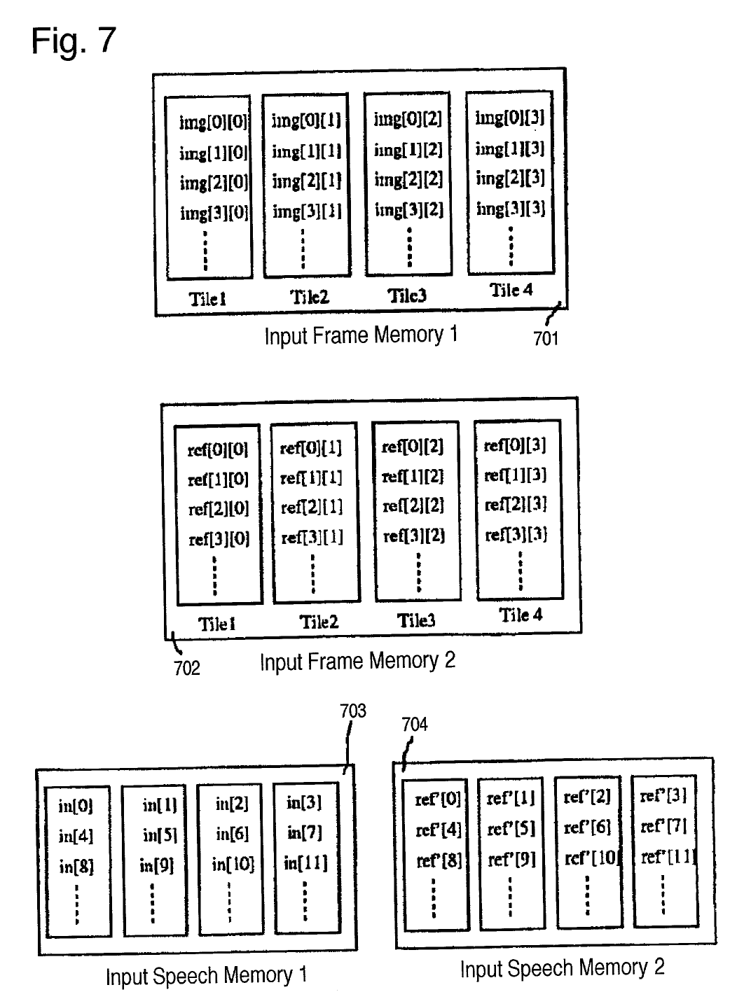

FIG. 7 illustrates the result of memory distribution crossing over tiles when the example shown in FIG. 6 is applied to the processing shown in FIG. 5. Four tiles are obtained for input frame memories 701 and 702 and input speed memories 703 and 704. The input frame memories 701 and 702 and the input speed memories 703 and 704 correspond to input frame memories 611 and 612 and input speed memories 613 and 614, respectively.

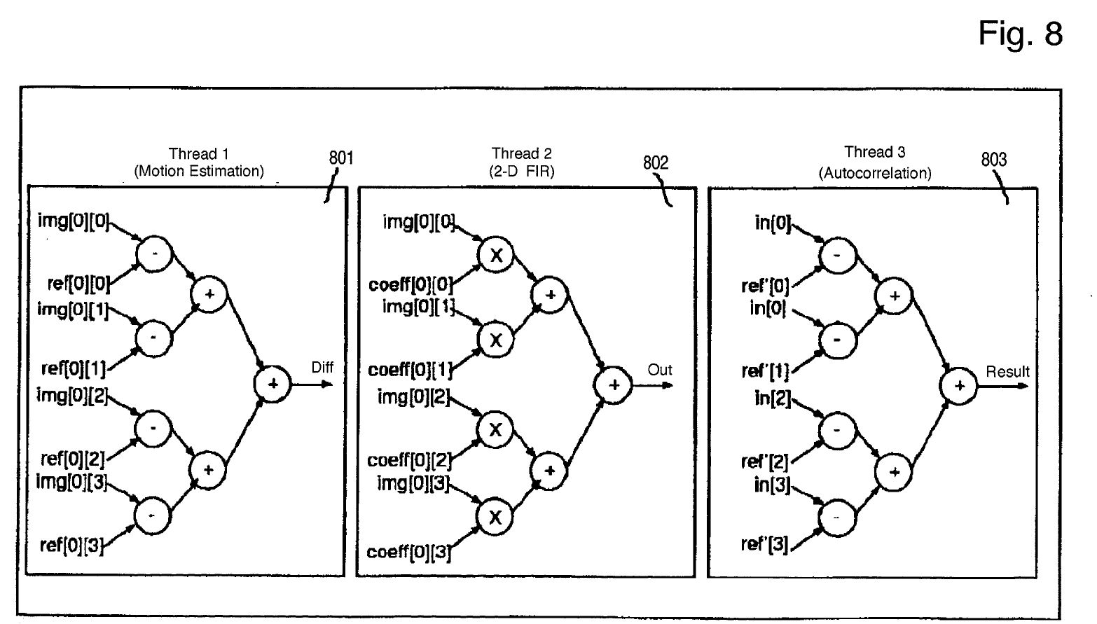

FIG. 8 illustrates three threads obtained as the result. Threads 801, 802 and 803 correspond to applications of the motion estimation 601, the finite impulse (FIR) filter 602 and the autocorrelation 603 shown in FIG. 6, respectively. The threads 801, 802 and 803 are outputted as “Diff”, “Out” and “Result” of the target hardware 604, and are stored in output frame memories 615, 616 and 617.

{First scheduling }

For the thread extracted in the above mentioned first division, the first scheduling is carried out (505 in FIG. 5). The purpose of this processing is to allocate an ASAP (as soon as possible) control step value and its moving range for each thread. In order to further consider the design flow, the list of the threads located in the priority order is allocated to respective steps. The allocation can be carried out by considering the following priority list:

(a) P list 1: a list of threads having a moving range which does not exceed a predetermined threshold (as in a real time I/O access).

(b) P list 2: is composed of threads having activity which not less than a predetermined threshold.

(c) P list 3: includes a thread belonging to a loop and a preceding value which is already scheduled.

(d) P list 4: a list of threads corresponding to a branch condition.

(e) P list 5: composed of pipeline/parallel threads clearly defined by a user (multi-threading in Java).

(f) P list 6: a list of threads having immediately succeeding elements.

(g) P list 7: constitutes remaining threads.

First, the P list 1 is considered to carry out the scheduling for all the nodes in the present control step. Otherwise, delay of the mobility results in elongation of the scheduling. Accordingly, the mobility is considered to be good priority function.

Next, a further thread is loaded. In order to reduce the reconfiguration overhead by realizing a further quick hardware utilization, the P list 2 is exclusively considered for the DRL circuit. In addition, in a high priority, a stream of a loop having a preceding value already scheduled. This is carried out to reduce the number of intermediate registers and to reduce the context switching in the same loop. Then, a condition corresponding to the branch condition is solves. This gives many options by scheduling the branch node.

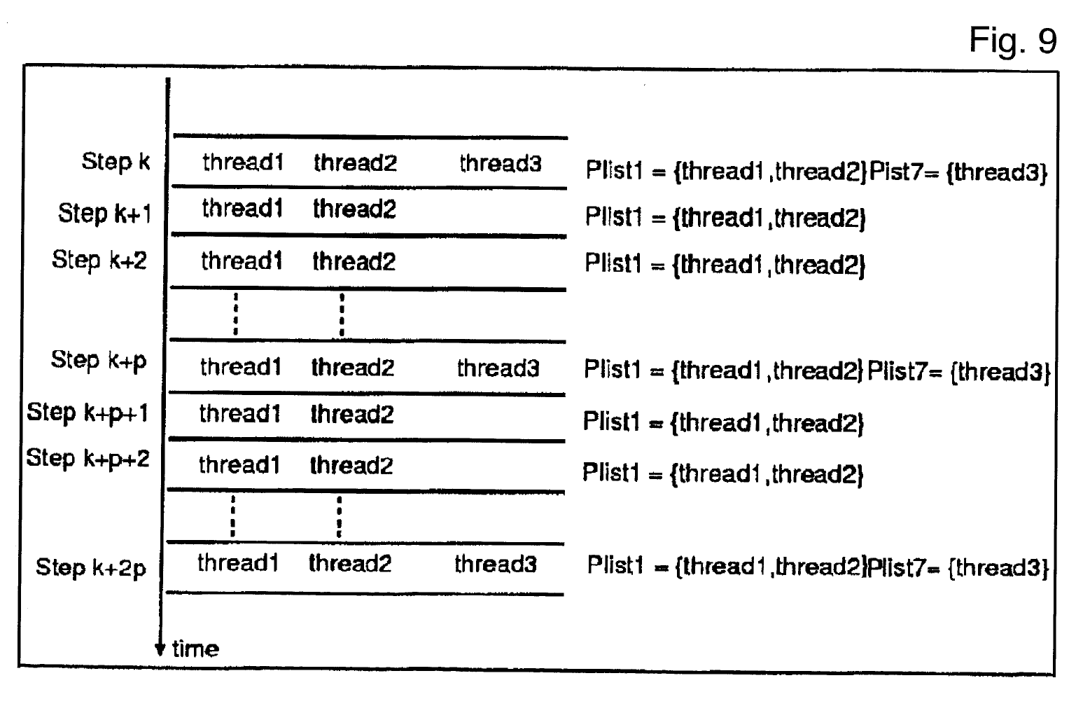

FIG. 9 illustrates the result of the algorithm in the case that it is applied to the example of FIG. 6. It is assumed that a sampling rate for the audio processing is p times the sampling rate of the video signal. In this case, if the actual step becomes different, since the mobility range of the threads 1 and 2 is one clock cycle, the threads 1 and 2 are placed at the same order in the P list 1. In addition, the thread 3 is added to the P list 7 (FIG. 9).

{Similarity cost}

After the first scheduling (505 in FIG. 5), a total area is estimated, and whether or not the estimated total area meets with the area restriction is discriminated. When the estimated total area meets with the area restriction, the hardware cells are considered to be sufficient, and the succeeding threading is carried out. On the other hand, when the estimated total area does not meet with the area restriction, the similarity metrics (506 in FIG. 6) is calculated for all combinations of thread pairs. A matrix and a similar matrix are estimated. The cost corresponds to the reduction in area obtained after the best combination is achieved by any of the following processings.

(a) Two different thread pairs are combined. The cost for this is used at any point between the first allocation (507 in FIG. 5) and the allocation-scheduling (508 in FIG. 5).

(b) The same thread is divided. It is updated at each time a corresponding cost is used in a succeeding step of the compiler. In this case, it is exclusively considered in the allocation-scheduling (508 in FIG. 5).

Here, the similarity cost is explained in further detail. Two threads 1 and 2 having an area 1 and an area 2 as the area, respectively, are considered. In this case, the similarity cost is:

“similarity cost”=“area 1”+“area 2”−“area 12”

where “area 12” is a resultant area after the threads 1 and 2 are combined. On the other hand, in the case of dividing the same thread 1, the similarity cost is:

“similarity cost”=“area 1”+“new area 1”

where “new area 1” is a new area obtained after the division of the thread. Referring to FIG. 5, and assuming that each bit operation is carried out with one hardware cell, the area of the threads 801, 802 and 803 becomes “71”, “449” and “71”, respectively.

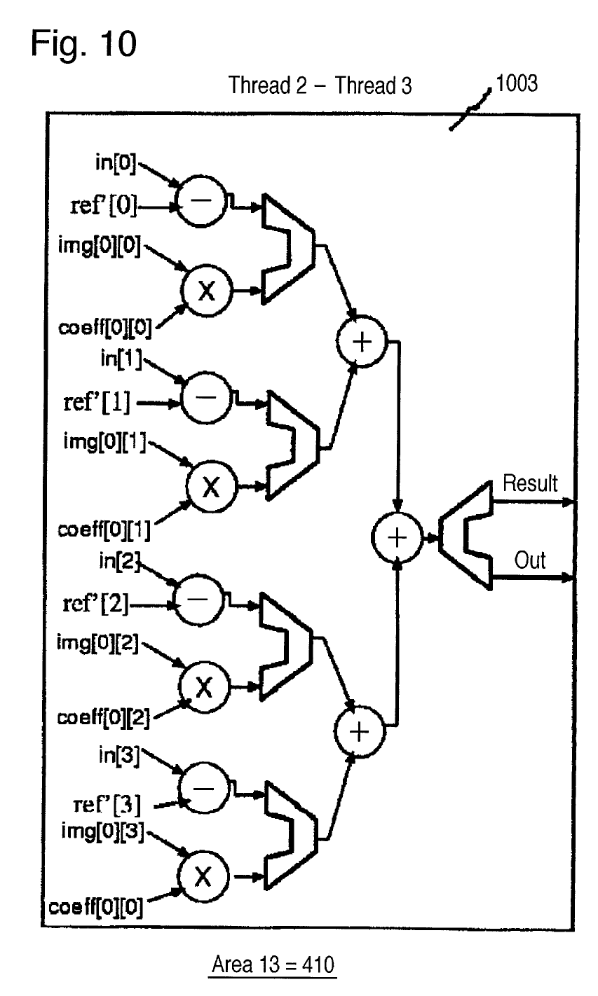

FIG. 10 illustrates the result of the first scheduling for the example shown in FIG. 6. This example is that the threads 1 and 2 are connected. The similarity cost is greatly dependent upon the target VLSI circuit. The reason for this is that: The hardware amount required by the multiplexor is more significant in DRL/FPGA than in ASIC, when it is compared with the amount of other operations and logic function units. Therefore, the hardware can be further reduced in the ASIC.

{First allocation}

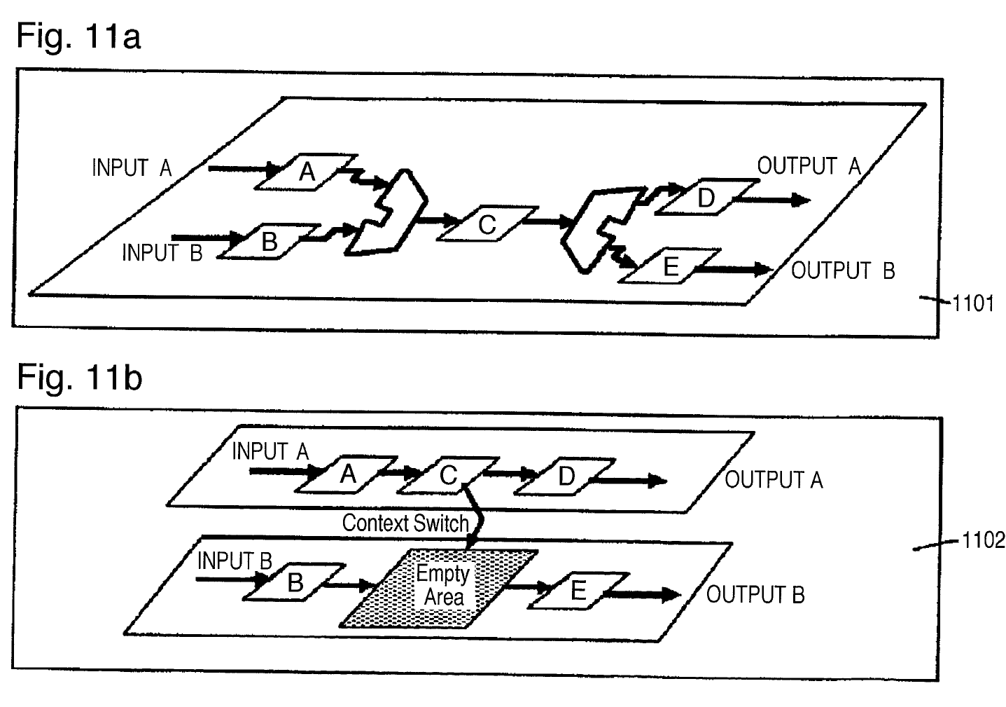

By using the similarity cost, the first allocation (507 in FIG. 5) is carried out. The purpose of this processing is to share a maximum number of function units between control steps. This is effective in reducing the number of multiplexors and the code size, and is important to an embedded application. The principle is that: A pair of threads belonging to different steps (in order to give no influence to concurrency) and having a high similarity cost, are selected from the similarity matrix, and then, are combined with a new thread. The pair of threads are removed from the process or matrix iterated until the area restriction is satisfied or until all pairs of threads belonging to different control steps are processed. The consideration of those pairs in the lowering order of the similarity nodes gives an advantage for well investigating the whole area. In the case of DRL, it is possible to take two allocation manners as shown in FIGS. 11a and 11b. The thread pairs resultantly obtained can share a similar block of those threads by using the multiplexor 1101, or can be mapped as two kinds of contexts 1102 using a context switch. In the latter case, since no multiplexor is used, a further high performance can be provided in presenting the area and the waiting time. Some number of restrictions as follows are applied to a limited context number.

(a) Connectivity between threads

It is better since a highly connected threads are mapped in the same context. However, a low interconnected threads are mapped to different contexts. This is to minimize the use of the registers.

(b) Number of discrete similar blocks in the same path for reducing the delay time generated by the multiplexor.

(c) Number of control steps between threads, frequently occurring in order to avoid the context switching.

When the algorithm of the first allocation (507 in FIG. 5) does not sufficiently meet with the area restriction, the allocation-scheduling 508 is executed for the thread allocated in the same control step. Thereafter, a new step is gradually generated.

First, the thread belonging to the list having the lowest priority (P list 7) and having the highest similarity metrics, is executed. In addition, a corresponding control step is subdivided into two control steps. The area is estimated, and the processing is iterated until all the elements of the list are processed. Thereafter, the thread belonging to the list having the secondly lowest priority (P list 6) is processed in a similar manner. This processing is iterated until the thread belonging to the list having the highest priority (P list 1) is processed.

Here, an importance is that if one thread is selected, only one additional condition is inserted into a corresponding control step. Namely, when the list is considered, the threads belonging to the list having the highest priority are not allowed to share the thread.

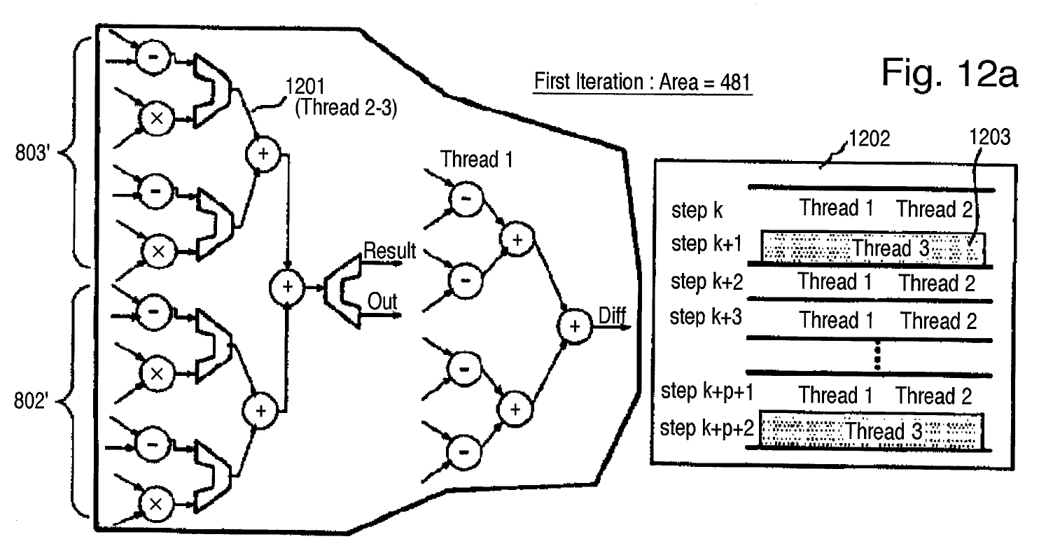

FIGS. 12a, 12b and 12c illustrate the result of the above mentioned allocation-scheduling step when it is applied to the example shown in FIG. 5.

FIG. 12a is a first iteration result (area=481). Since the thread 803′ belongs to the P list 7, the thread 803′ is selected at a first place. The selected thread 803′ is combined to a thread 802′ having the best similarity cost to the thread 803′, so that a new thread 1201 is constituted. In a corresponding scheduling 1202, a new condition 1203 is inserted.

FIG. 12b is a second iteration result (area=368) succeeding to the first iteration mentioned above. In this iteration, the P list 1 is considered. According to the similarity cost matrix, the best similarity cost is {thread 2, thread 3′}. A corresponding thread 1204 can be realized of a reduced amount of hardware. In this case, the control step scheduling becomes as a scheduling 1205.

FIG. 12c is a third iteration result (area=321) succeeding to the second iteration mentioned above. In this iteration, the thread 1 is selected from the P list 1 as a next candidate, and is combined with the thread 1204, so that a thread 1206 is generated. In this case, the control step scheduling becomes as a scheduling 1207.

{Threading}

This processing is subdivided into two main steps. First, in a thread adjustment explained hereinafter, a tradeoff between the waiting time and the area is investigated for each thread (first step). At this time, respective delays of function units, registers and multiplexors care considered. In a second step called a thread optimization, the respective threads are physically mapped to positions correlated to the target hardware, by means of a manner for optimizing the interconnection distribution. In a low level synthesis at this stage, an interconnection delay information can be taken.

(1) Thread adjustment (first step)

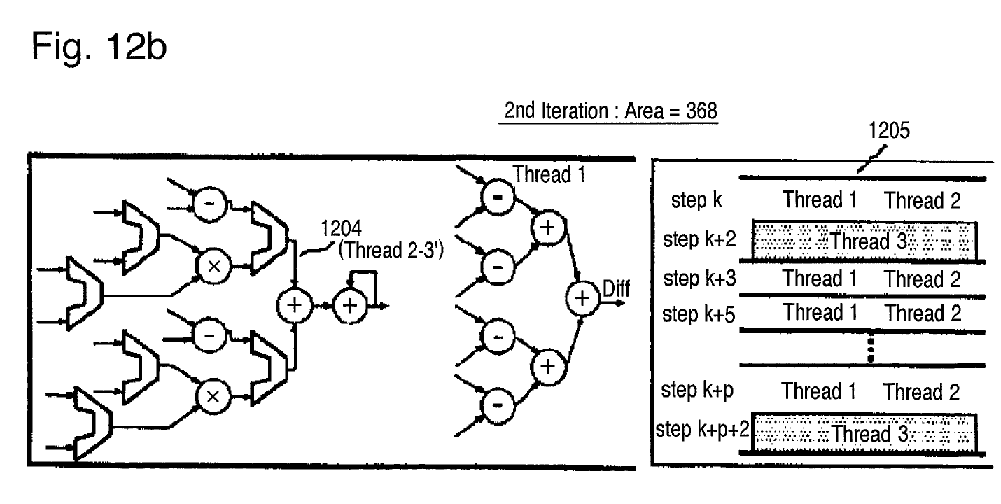

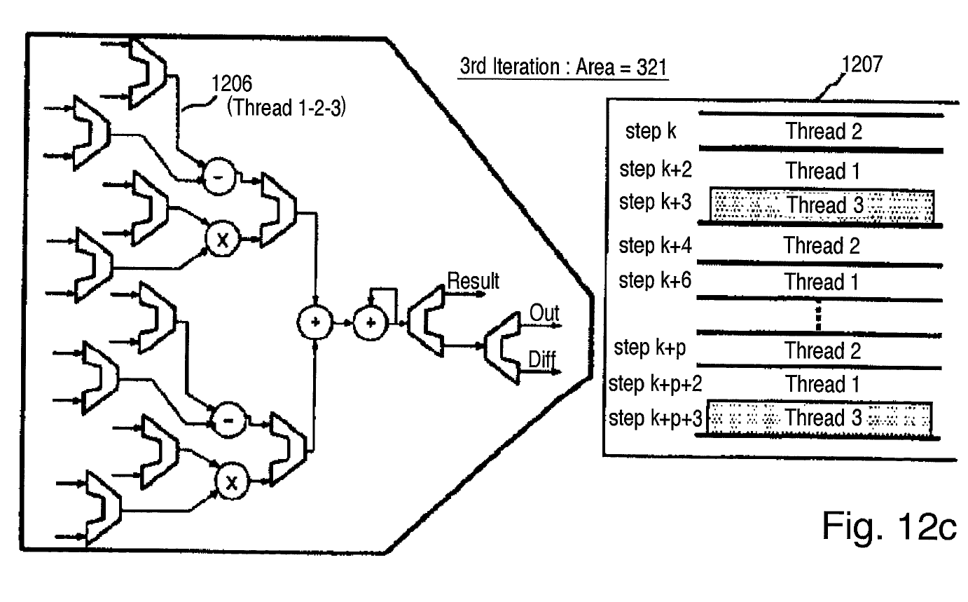

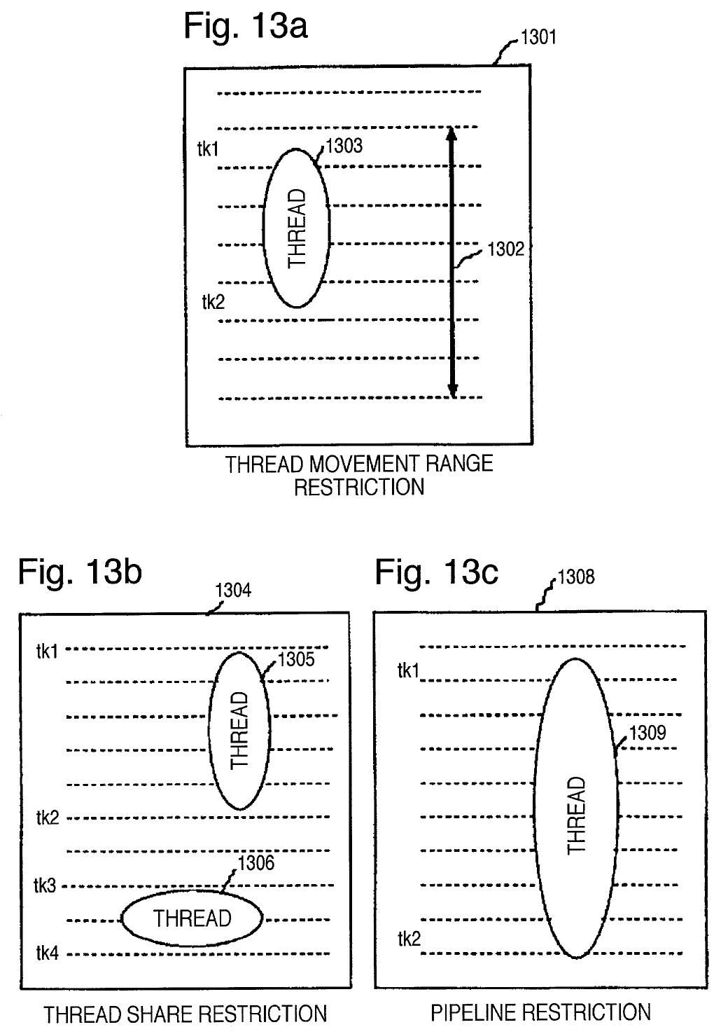

In this stage, each thread is processed in an independent manner in order to cause the thread to meet with the waiting time restriction. Specifically, it is handled in three different cases as shown in FIGS. 13a, 13b and 13c.

(a) Movement range restriction

For example, in a movement range restriction shown in FIG. 13a, a waiting time (tk2−tk1) must be smaller than a movement range 1302.

(b) Thread sharing restriction

In a thread sharing restriction shown in FIG. 13b, threads having a some number of function units are never overlapped in time to each other. Assume that each of threads 1305 and 1306 includes some number of function units, and have waiting times (tk2−tk1) and (tk4−tk3), respectively. In this case, the thread adjustment is carried out to surely make (tk2−tk1) smaller than (tk4−tk3+tMob), where “tMob” is the movement range of the thread 1306.

(c) Pipeline restriction

In a pipeline restriction 1308 shown in FIG. 13c, a waiting time of a thread 1309 belonging to a loop never exceeds a predetermined value. This restriction is to minimize the number of steps in the pipeline for each thread.

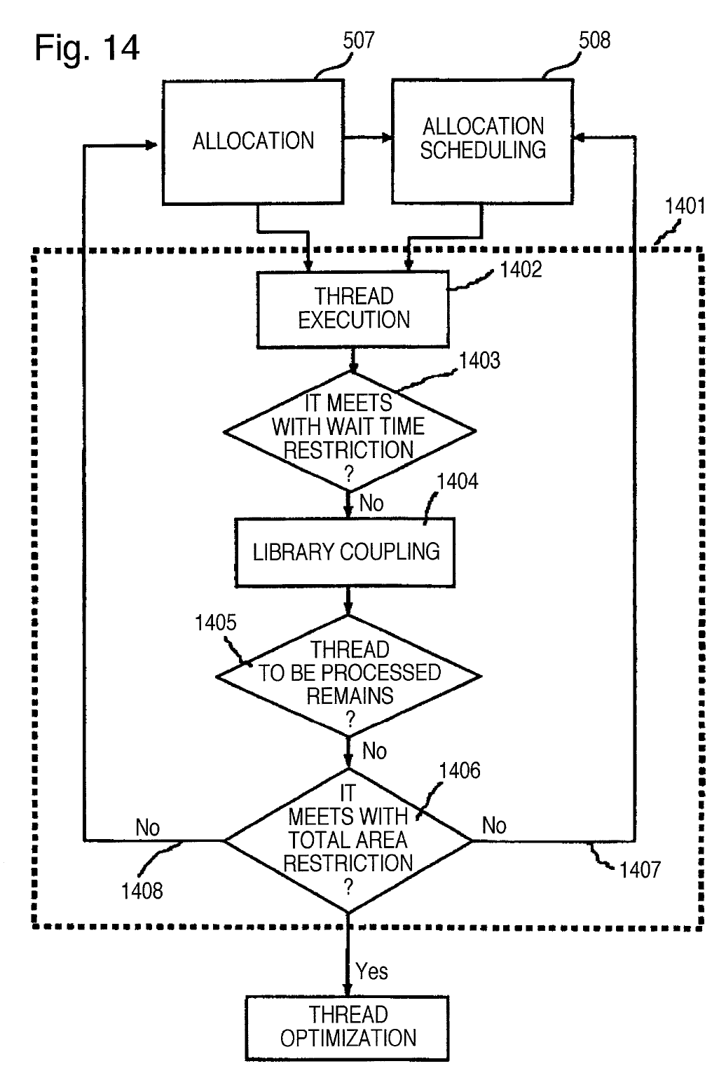

FIG. 14 is a flow chart of the thread adjustment. First, the thread is executed (step 1402). When the waiting time of the thread does not meet with one of the above mentioned restrictions (step 1403), the algorithm finds out a best solution corresponding to a minimum thread area meeting with the restriction. This is carried out by a library coupling (step 1404). A similar processing is carried out for all the threads (step 1405). Finally, a total resultant area is estimated (step 1406). When the total resultant area is larger than an available hardware area, the allocation 507 and the allocation-scheduling 508 as shown in FIG. 5 are executed. Until the area/waiting time restrictions are satisfied, this processing is iterated for all the threads subjected to influence by the combining processing. Since the size of each thread is relatively small, the library coupling can be achieved relatively quickly.

(1) Thread optimization (second step)

The purpose of this processing is to carry out the placement and routing of the nodes for each thread in an efficient manner, and also to elevate the accuracy of the area/waiting time metrics for each thread.

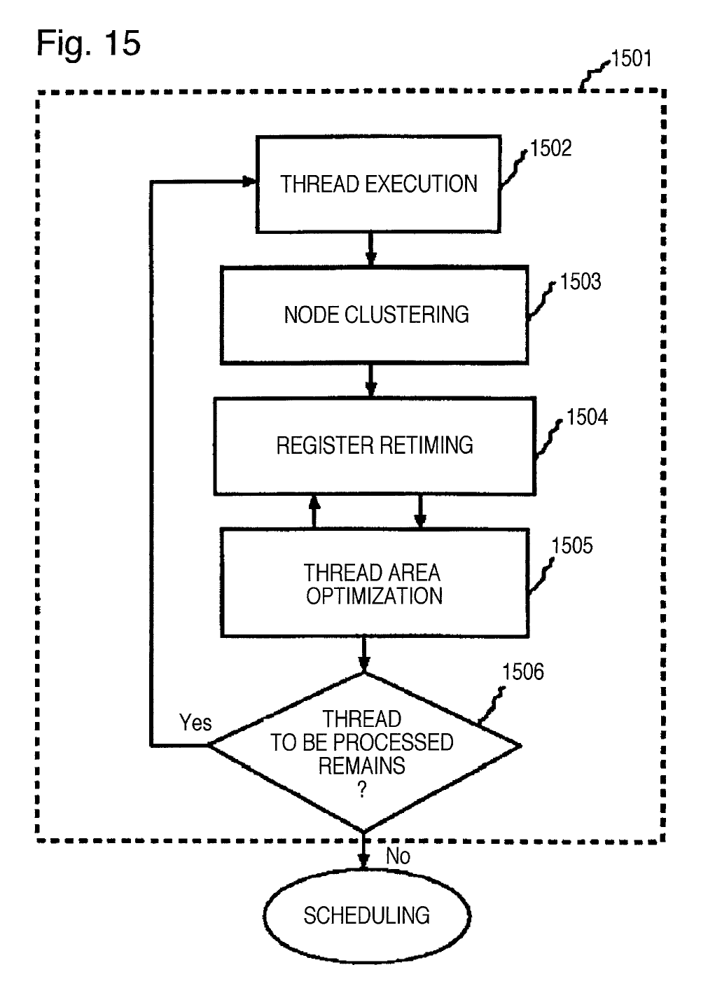

FIG. 15 is a flow chart of the thread optimization. First, the thread is executed (step 1502). By using a connectivity restriction as a unique priority, the algorithm investigates the critical path for each thread (a path having a maximum signal propagation delay in all signal propagating paths from an input terminal to an output terminal in a circuit block in the LSI), and assembles nodes into a cluster (each layer is constituted of a plurality of units, and the layers excluding the input layer is ordinarily divided into a set of plural units called a cluster) during a node clustering phase (collecting and classifying mutually similar sample vectors of a pattern by introducing the similarity into a pattern space) (step 1503). In the thread having the waiting time longer than one clock cycle, the number of registers to be inserted in the thread is calculated at a later stage. A register re-timing is carried out (step 1504) in order to further reduce the thread area by means of the library coupling (step 1505). This processing is iterated until a solution corresponding to a minimum area and meeting with the waiting time restriction is found out.

In the following, the processing of the node clustering and the register re-timing will be explained simply.

(a) Node clustering

A main purpose of this processing is to group the nodes in an optimum manner. The following layers are determined in a data path circuit.

(a-1) Elementary block: cluster of unit cells. Since the cells are interconnected through a local interconnection network, it has the property of a low propagation delay (average delay from an input pulse to an output pulse in a logic circuit).

(a-2) Macro block: set of closest elementary blocks. The elementary blocks can be interconnected through a synchronous register, depending upon a propagation delay restriction.

The algorithm starts to search a node belonging to the most critical path of the thread. The algorithm further selects two nodes having a maximum connectivity from a closeness measure matrix, and places the selected nodes into the same elementary block, the same macro block or different macro blocks, depending upon some number of restrictions.

Here, the clustering procedure will be explained.

In order to determine to what layer the group of nodes is mapped, some conditions, for example, the following conditions are considered.

C1: two nodes belonging to the critical path

verification of the area restriction

C21: elementary block area

C22: macro block area

C23: total circuit area of the target VLSI

C3: communication between two nodes exceeds a predetermined threshold.

Thereafter, the nodes are assembled into the following blocks:

elementary block:

In the case that the highly interconnected nodes belongs to the critical path or the already mapped pair has a sufficient room, it is given with the following condition:

[C1 AND C21 AND C3] OR [NOT C1 AND NOT C21]

macro block:

In the case that the highly interconnected nodes does not belong to the critical path or the already mapped pair does not have a sufficient room, it is given with the following condition:

[NOT(C1) AND C3] OR [C1 AND NOT (C21)]

different macro block:

In the case that the communication between two nodes is smaller than the predetermined threshold, and neither the area of the reconfigurable circuit nor the one macro block can support the threads of the whole, it is given with the following condition:

[NOT (C4) AND (NOT (C22) OR NOT (C29))]

As mentioned above, by localizing the highly interconnected nodes, it is possible to optimally reduce the total length and the complexity of the interconnection.

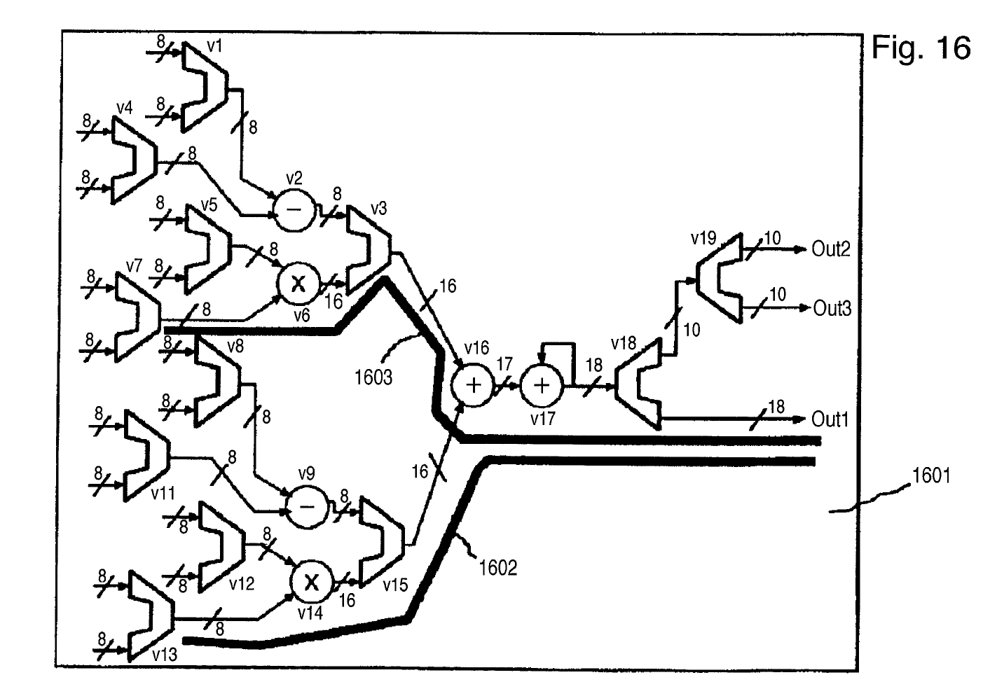

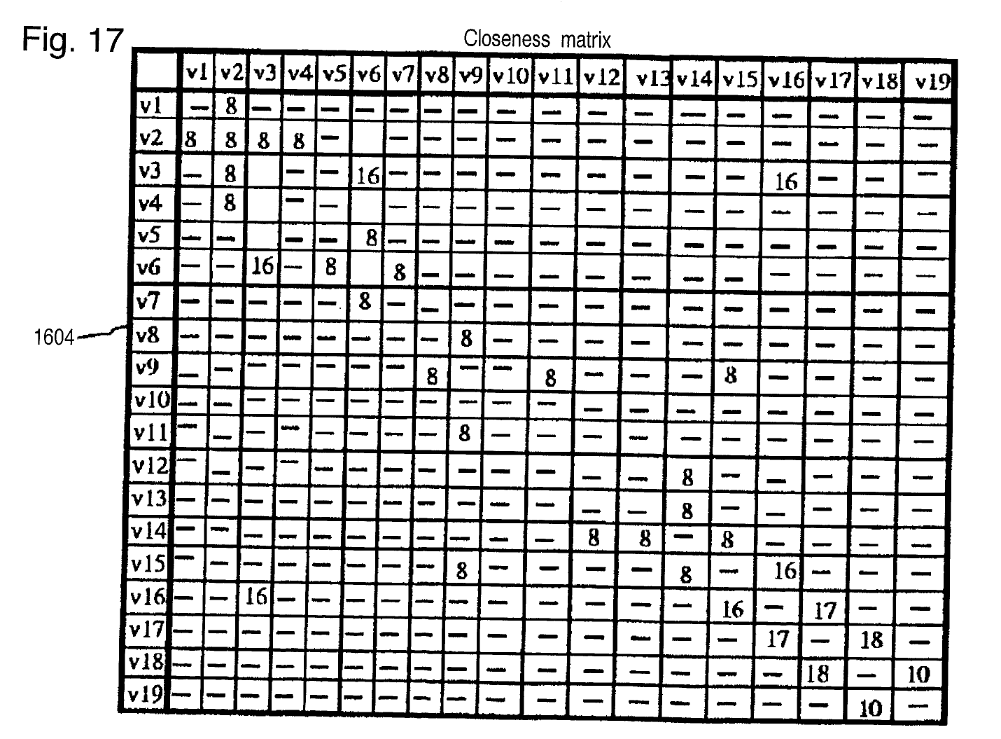

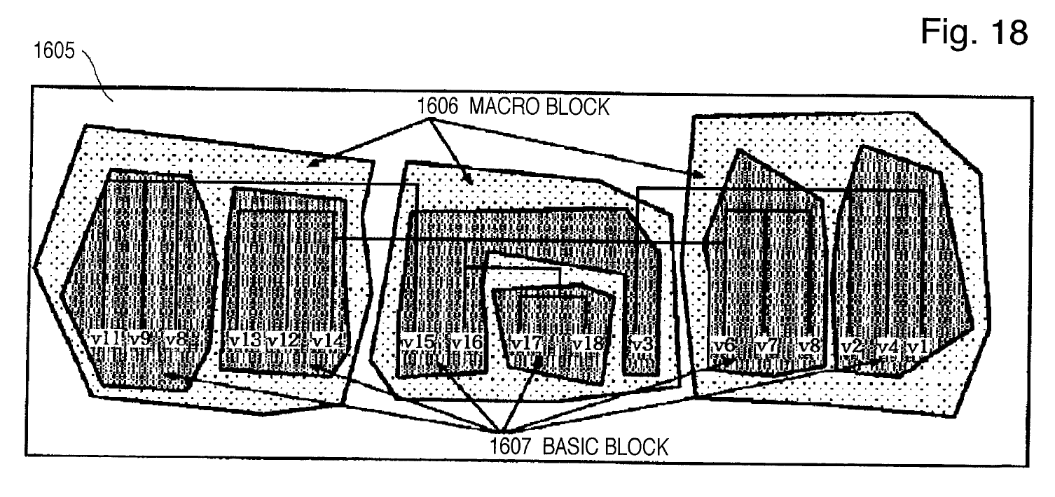

The above matter will be explained in detail with reference to the thread 1206 shown in FIGS. 12a, 12b and 12c. FIGS. 16 to 18 illustrate the result corresponding to the node clustering of the thread 1206 shown in FIGS. 12a, 12b and 12c. First, as shown in FIG. 16, labels vi (i=1 to 19) are allocated to all the nodes in the thread 1206, and critical paths 1602 and 1603 are found out. Thereafter, in order to constitute a cluster tree 1605 as shown in FIG. 18, a matrix as shown in FIG. 17 is calculated. This tree shows the priority order of a combining processing. Nodes v17 and v18 which are found out to be closest to each other, constitutes a first pair candidate to be mapped in an elementary block (basic block) 1607. At a last stage, the algorithm generates three macro block 1606 and six elementary blocks (basic blocks) 1607.

(b) Register re-timing

This task is exclusively carried out for the threads having the waiting time “th” longer than a clock cycle “tc”. In this case, when a floor (x) indicates a minimum integer near to the number “Cp” of the paths of the thread having the waiting time “th” longer than the clock cycle “tc”, and to “x”, the number of registers to be inserted is 10. While carrying out various combinations, the register timing is calculated to estimate the minimum area.

For example, assuming tc=60 ns, the node delays as shown in FIG. 18 are considered. The waiting time of the thread is the waiting time of the critical path, and is equal to

“tc”=tv7+tv7.6+tv6+tv3.6+tv3+tv3.16+tv16.17+tv17+tv17+tv17+tv17, tv18+tv18+tv18, v19+tv19tv19=86.5 ns

The number of division or the number of registers to be inserted is 10. Three combinations 1702, 1703 and 1704 of the register re-timing are estimated. Here, the combination 1702 is a combination of {v16•v17•v18} and {v3•v6•v7}, and the combination 1703 is a combination of {v16•v17} and {v18•v3•v6•v7}. The combination 1704 is a combination of {v16•v17•v18•v3} and {v6•v7}. For each combination, the library coupling is carried out for all the function units to meet with the waiting time restriction. The minimum area is maintained as an optimum solution.

{Third scheduling}

As the result of the threading, it is possible to estimate the whole area during the register re-timing phase. A third scheduling 510 is carried out to gradually increase the throughput of the circuit. This is similar to the algorithm in the second scheduling 508, but different in using the priority list in a reverse order. In the third scheduling 510, namely, the thread pair having a low similarity is selected from the highest priority list (P list 1). The thread belonging to that list is separated from the corresponding group. A similar processing is iterated for all the lists.

{Second division }

Next, the thread is subdivided into contexts (step 511 in FIG. 5). This is applied to the DRL or the multi-chip circuit. The algorithm is based on the simulated annealing, and provides a general solution which minimizes the connectivity restriction between the threads. The connectivity cost between two threads are the number of variables in common to these threads, and is the number of registers used to restore the data between the contexts in the case of DRL, or the number of on-chip interconnections in the case of the multi-chip circuit.

In the above mentioned description, the processing in the back-end compiler 105 in the system shown in FIG. 1, has been explained for each processing part. The blocks shown in FIG. 5 as the processing correspond to respective processing parts in the back-end compiler 105.

As mentioned above, according to the present invention, it is possible to describe the electronic circuit model with a high level description language familiar to the programmer, and also it is possible to carry out a further accurate cost estimation and a design result of a high quality.

1. A compiling method including:
a first step of carrying out a syntax analysis of a description file describing a desired electronic circuit model with a predetermined high level description language, to generate a control data flow graph having a predetermined graph structure; and
a second step of dividing said control data flow graph into threads composed of a set of a plurality of connected nodes and achieving a particular function, and optimizing the divided threads to meet with a predetermined area restriction and a predetermined waiting time restriction, to obtain designation information of the number, the function, the placement and routing of logic cells for the desired electronic circuit model.

2. A compiling method claimed in claim 1 wherein the optimization in said second step is carried out by estimating a minimum boundary of an area and a waiting time in connection with any of a function unit, a register and a multiplexor.

3. A compiling method claimed in claim 1 wherein the optimization in said second step is carried out by first optimizing the divided threads to meet with th e predetermined area restriction, and thereafter optimizing the optimized threads to meet with the predetermined waiting time restriction.

4. A compiling method claimed in claim 3 wherein said second step includes:
a top-down processing step carrying out the optimization in connection with the predetermined area restriction and the predetermined waiting time restriction, in the order from a highest level divided thread; and
a down-top processing step of dividing a lower level divided thread optimized in said top-down processing step, into some number of threads, to assemble into a predetermined context or a predetermined circuit.

5. A compiling method claimed in claim 4 wherein said top-down processing step includes:
a first dividing step for dividing the control data flow graph into threads composed of a set of the plurality of connected nodes and achieving the particular function;
a first scheduling step of allocating a predetermined control step and a thread moving range in that step for a thread obtained in the first dividing step, the first scheduling step also allocating the order of priority for the threads respectively allocated with the control steps, in accordance with a plurality of priority order lists previously set;
a first area restriction determining step for estimating a total area of the threads allocated in the first scheduling step, and of determining whether or not the estimated total area meets with the predetermined area restriction;
when it is determined in the first area restriction determining step that the estimated total area does not meet with the predetermined area restriction, a similarity cost calculating step for calculating a similarity cost in connection with an area for all thread pair combinations of the threads obtained in the first dividing step;
a first allocation step of selecting, from the thread pairs, a thread pair belonging to different control steps and having a further high similarity cost, with reference to the similarity costs obtained in the similarity cost calculating step, the first allocation step further obtaining a new thread by combining the selected thread pair as a new thread to another thread;
a second area restriction determining step for estimating a total area for the new thread pair obtained in the first allocation step, and of determining whether or not the estimated total area meets with the predetermined area restriction;
when it is determined in the second area restriction determining step that the estimated total area does not meet with the predetermined area restriction, an allocation-scheduling step of selecting, from the threads included in the list, a thread pair belonging to the same control step and having a further high similarity cost, in accordance with the plurality of priority order lists, in the order from a low priority list, the allocation-scheduling step obtaining a new thread pair by combining the selected thread pair as a new thread to another thread, and subdividing the control step allocated to the new thread pair, into two control steps having the same content;
when it is determined in the first or second area restriction determining step that the estimated total area meets with the predetermined area restriction, a thread processing step of investigating a trade-off between the area restriction and the waiting time restriction for the new thread pair obtained in the first allocation step or in the allocation-scheduling step, and carrying out the placement and routing of nodes to meet with both the restrictions, and
wherein said down-top processing step includes:
a second scheduling step of selecting and separating, for the threads placed and routed in the thread processing step, a thread pair having a low similarity, from the threads included in the list, in accordance with the plurality of priority order list, in the order from a high priority list; and
a second dividing step of assembling the thread pairs separated in the second scheduling step, into a context or a circuit which minimizes a connecting restriction between threads.

6. A compiling method claimed in claim 5 wherein the predetermined time restriction in said thread processing step includes three restrictions, a movement range restriction defined as a movement range of the thread in said control step, a thread sharing restriction defined as an overlapping in time between the threads in said control step, and a pipeline restriction defined as a waiting time for the thread belonging to one loop of a pipeline processing executing said control step in parallel.

7. A compiling method claimed in claim 5 wherein said thread processing step includes:
when new thread pairs obtained in said first allocation step or said allocation-scheduling step include a thread pair which does not meet with one of said movement range restriction, said thread sharing restriction and said pipeline restriction, a thread adjusting step for finding out a solution having a minimum thread area meeting with those restrictions for said thread pair; and
a thread optimizing step for investigating a critical path having a maximum delay, for a thread pair obtained in said thread adjusting step, on the basis of a predetermined connectivity restriction, to assemble nodes into a cluster, when there exists a thread having a waiting time longer than a predetermined clock cycle, said thread optimizing step obtaining the number of registers to be inserted into said thread, and estimating a minimum area by timing said registers, thereby to obtain a solution meeting with said predetermined waiting time restriction.

8. A compiling method claimed in claim 7 wherein said thread processing step includes:
a step of calculating a closeness matrix representing the closeness of nodes of each thread for the thread pair obtained in said thread adjusting step;
a step for generating a node cluster tree by grouping nodes based on said closeness matrix;
a step for investigating a critical path having a maximum delay on the basis of the connectivity metrics of each node pair in said node cluster tree; and
a step of grouping said node pairs included in said node cluster tree on the basis of whether or not the node pair belongs to said critical path, thereby to constitute an elementary block, and further grouping elementary blocks closest to each other, to constitute a macro block.

9. A compiling method claimed in claim 7 wherein in said thread adjusting step and in said thread optimizing step, the step for finding out the solution is carried out by connecting a library supplying a set of function units which have corresponding area and delay and which have a predetermined parameter which can be set.

10. A compiling method claimed in claim 5 wherein when the depth of at least one branch in a group of connected nodes exceeds a predetermined threshold value, the thread divided in said first dividing step is defined as a block which is found out between two continuous memory accesses or I/O accesses sharing the same I/O port, or as an express machine introduced by a user, or as a branch connecting node of said control data flow graph.

11. A compiling method claimed in claim 10 wherein said control step includes a loop having a memory access, said thread found out between the continuous I/O accesses is given with a loop extension dependency for determining whether or not a memory parallel exists in the iteration of said loop.

12. A compiling method claimed in claim 1 wherein a layout metrics for evaluating the area and the delay is used for the optimization in said second step.

13. A compiling method claimed in claim 1 wherein said electronic circuit model is constituted of a hardware cell formed of a predetermined number of basic elements.

14. A compiling method claimed in claim 13 wherein said hardware cell is one of an application specific integrated circuit, a field programmable gate array and a dynamic reconfigurable logic.

15. A synthesizing system including:
a front-end compiler means for carrying out a syntax analysis of a description file describing a desired electronic circuit model with a predetermined high level description language, to generate a control data flow graph having a predetermined graph structure; and
a back-end compiler means for dividing the control data flow graph into threads composed of a set of a plurality of connected nodes and achieving a particular function, and optimizing the divided threads to meet with a predetermined area restriction and a predetermined waiting time restriction, to obtain designation information of the number, the function, the placement and routing of logic cells for the desired electronic circuit model.

16. A synthesizing system claimed in claim 15 wherein said back-end compiler means carries out optimization by estimating a minimum boundary of an area and a waiting time in connection with any of a function unit, a register and a multiplexor.

17. A synthesizing system claimed in claim 15 wherein said back-end compiler means includes:
a first dividing means for dividing the control data flow graph into threads composed of a set of the plurality of connected nodes and achieving the particular function;
a first scheduling means of allocating a predetermined control step and a thread moving range in that step for a thread obtained in the first dividing means, the first scheduling means also allocating the order of priority for the threads respectively allocated with the control steps, in accordance with a plurality of priority order lists previously set;
a first area restriction determining means for estimating a total area of the threads allocated in the first scheduling means, and for determining whether or not the estimated total area meets with the predetermined area restriction;
when it is determined in the first area restriction determining means that the estimated total area does not meet with the predetermined area restriction, a similarity cost calculating means for calculating a similarity cost in connection with an area for all thread pair combinations of the threads obtained in the first dividing means;
a first allocation means of selecting, from the thread pairs, a thread pair belonging to different control steps and having a further high similarity cost, with reference to the similarity costs obtained in the similarity cost calculating means, the first allocation means further obtaining a new thread by combining the selected thread pair as a new thread to another thread;
a second area restriction determining means for estimating a total area for the new thread pair obtained in the first allocation means, and for determining whether or not the estimated total area meets with the predetermined area restriction;
when it is determined in the second area restriction determining means that the estimated total area does not meet with the predetermined area restriction, an allocation-scheduling means for selecting, from the threads included in the list, a thread pair belonging to the same control step and having a further high similarity cost, in accordance with the plurality of priority order lists, in the order from a low priority list, the allocation-scheduling means obtaining a new thread pair by combining the selected thread pair as a new thread to another thread, and subdividing the control step allocated to the new thread pair, into two control steps having the same content;
when it is determined in the first or second area restriction determining means that the estimated total area meets with the predetermined area restriction, a thread processing means of investigating a trade-off between the area restriction and the waiting time restriction for the new thread pair obtained in the first allocation means or in the allocation-scheduling means, and carrying out the placement and routing of nodes to meet with both the restrictions;
a second scheduling means for selecting and separating, for the threads placed and routed in the thread processing means, a thread pair having a low similarity, from the threads included in the list, in accordance with the plurality of priority order list, in the order from a high priority list; and
a second dividing means for assembling the thread pairs separated in the second scheduling means, into a context or a circuit which minimizes a connecting restriction between threads.

18. A synthesizing system claimed in claim 17 wherein the predetermined time restriction includes three restrictions, a movement range restriction defined as a movement range of the thread in said control step, a thread sharing restriction defined as an overlapping in time between the threads in said control step, and a pipeline restriction defined as a waiting time for the thread belonging to one loop of a pipeline processing executing said control step in parallel.

19. A synthesizing system claimed in claim 17 wherein in said thread processing means carries out the placement and routing of said nodes, by connecting a library supplying a set of function units which have a predetermined area and a predetermined delay and which have a predetermined parameter which can be set.

20. A synthesizing system claimed in claim 15 wherein said electronic circuit model is constituted of a hardware cell formed of a predetermined number of basic elements.

21. A synthesizing system claimed in claim 20 wherein said hardware cell is one of an application specific integrated circuit, a field programmable gate array and a dynamic reconfigurable logic.

22. A recording medium recording a computer program for causing a computer to execute a processing for carrying out a syntax analysis of a description file describing a desired electronic circuit model with a predetermined high level description language, to generate a control data flow graph having a predetermined graph structure, and another processing for dividing the control data flow graph into threads composed of a set of a plurality of connected nodes and achieving a particular function, and optimizing the divided threads to meet with a predetermined area restriction and a predetermined waiting time restriction, to obtain designation information of the number, the function, the placement and routing of logic cells for the desired electronic circuit model.
